(19) United States
(12) Patent Application Publication
(10) Pub. No.: US 2020/0344511 A1
(43) Pub. Date: Oct. 29, 2020

(54) CONTENT DISTRIBUTION MANAGEMENT SYSTEM AND METHOD USING BLOCKCHAIN TECHNOLOGY

(71) Applicant: ALTICAST CORPORATION, Seoul (KR)

(72) Inventors: Chang Hoon CHO, Seoul (KR); Jung Ki MIN, Seoul (KR)

(21) Appl. No.: 16/760,177

(22) PCT Filed: Oct. 31, 2018
(86) PCT No.: PCT/KR2018/013089

§ 371 Date: Apr. 29, 2020

(30) Foreign Application Priority Data
Nov. 1, 2017 (KR) 10-2017-0144774

(51) Int. Cl. H04N 21/2543; H04L 9/06; G06Q 20/12; G06Q 20/22; G06Q 20/38

(52) U.S. Cl. CPC H04N 21/2543; H04L 9/0637; G06Q 20/385; G06Q 20/29; G06Q 20/123

(57) ABSTRACT

Disclosed a content distribution management system using blockchain technology, including a purchase transaction generator for generating a purchase transaction in response to a content purchase request signal from a user terminal; a broadcasting processor for broadcasting the generated purchase transaction; a transaction processor, in which, when content corresponding to the verified purchase transaction is used in the user terminal after the broadcasted purchase transaction is verified, usage transactions generated in response to the current status of usage of the content are collected; a transaction verifier for verifying the collected usage transactions; and a block generator for generating blocks corresponding to the verified usage transactions, wherein the transaction processor collects temporary usage transactions generated in the user terminal during use of the content, and analyzes the current status of usage of the content in consideration of the collected temporary usage transactions.

### BACKGROUND OF THE DISCLOSURE

### Field of the Disclosure

The present disclosure relates to a content distribution management technology using blockchain technology. More specifically, the present disclosure relates to a technical idea for generating transactions according to purchase and use of content and generating blocks based on the generated transactions and storing the generated blocks in the form of a distributed ledger, thereby ensuring integrity of content distribution and flows related to the same.

### Description of the Related Art

Globally, the market size and growth rate of technology related to a digital content distribution platform has been steadily increasing, and it is expected that the technology will continue to grow over the next several years.

In particular, as the mobile network develops, the size of the Over the Top (OTT) market is rapidly growing. In this regard, markets for premium content consumption and premium content platforms are expected to steadily grow.

In accordance with this market prospect, interest in the market size of Internet of Things (IoT) and devices related to IoT is also rising due to the IoT environment. In particular, media content is classified as the most exchanged and consumed information in combination with the IoT environment, and is expected to be distributed and consumed through various media.

A market related to technologies that combine various types of media content and the IoT environment is expected to rapidly grow. In addition, as use of the IoT environment increases, improvement in technologies related to content distribution management systems and billing systems is required.

In addition, as improvement in content distribution and billing suitable for the IoT environment is required, there is an urgent need for a strategy to preoccupy the future market by developing a novel content distribution management platform and a novel billing platform.

### SUMMARY OF THE DISCLOSURE

Therefore, the present disclosure has been made in view of the above problems, and it is an object of the present disclosure to provide a model for novel content distribution management.

It is another object of the present disclosure to ensure the integrity of content distribution management by applying blockchain technology to content distribution management.

It is another object of the present disclosure to block and prevent illegal distribution of content by applying blockchain technology to content distribution management.

It is another object of the present disclosure to design a model for a novel content distribution management platform to which blockchain technology is applied.

It is another object of the present disclosure to secure technical competitiveness for a novel content distribution management platform.

It is another object of the present disclosure to increase the reliability of billing using blockchain technology capable of implementing the integrity of content distribution management.

It is another object of the present disclosure to finely check the current status of usage related to content distribution by applying blockchain technology to content distribution management.

It is another object of the present disclosure to implement micro-billing for content distribution by applying blockchain technology to content distribution management.

It is another object of the present disclosure to provide blockchain technology for distributing a ledger in which transaction information is recorded to a P2P network rather than a central server so that participants may jointly manage the records. Therefore, in the conventional method, a trusted third party (TTP) for trusting the database of a central server is required, but the present disclosure may omit such a requirement.

It is yet another object of the present disclosure to improve security, transparency, safety, and efficiency compared to conventional centralized systems by using blockchain technology.

In accordance with the present disclosure, the above and other objects can be accomplished by the provision of a content distribution management system using blockchain technology, including a purchase transaction generator for generating a purchase transaction in response to a content purchase request signal from a user terminal; a broadcasting processor for broadcasting the generated purchase transaction; a transaction processor, in which, when content corresponding to the verified purchase transaction is used in the user terminal after the broadcasted purchase transaction is verified, usage transactions generated in response to the current status of usage of the content are collected; a transaction verifier for verifying the collected usage transactions; and a block generator for generating blocks corresponding to the verified usage transactions, wherein the transaction processor collects temporary usage transactions generated in the user terminal during use of the content, and analyzes the current status of usage of the content in consideration of the collected temporary usage transactions.

According to one embodiment, the user terminal may generate and broadcast the usage transactions when use of the content is normally terminated, and may generate and broadcast the temporary usage transactions before the usage transactions are generated.

According to one embodiment, the user terminal may generate the temporary usage transactions at regular intervals, or may generate the temporary usage transactions in response to an externally received request signal.

According to one embodiment, when the next temporary usage transaction or the usage transaction is not received during a critical time after the temporary usage transaction is received, the transaction processor may analyze the current status of usage using the last received temporary usage transaction.

According to one embodiment, when the usage transaction is received, the transaction processor may analyze the current status of usage using the usage transaction.

According to one embodiment, the transaction processor may calculate micro-billing information based on the analyzed current status of usage.

According to one embodiment, the transaction processor may calculate recommended content information corresponding to a user based on the analyzed current status of usage.

According to one embodiment, the current status of usage may include at least one of a total usage time, a usage time zone, a usage amount, the number of usage times, and a terminal used for the content.

According to one embodiment, the broadcasting processor may broadcast the generated blocks to the user terminal and a usage history collection system, and the user terminal and the usage history collection system may collect and verify the broadcasted blocks.

In accordance with another aspect of the present disclosure, there is provided a content distribution management system using blockchain technology, including a transaction verifier for receiving a purchase transaction generated in a service system when content is purchased and for verifying the received purchase transaction; a usage transaction generator for generating usage transactions by reflecting the current status of usage of the content corresponding to the verified purchase transaction and generating temporary usage transactions during use of the content; and a broadcasting processor for broadcasting at least one of the generated usage transactions and temporary usage transactions, wherein the service system collects and verifies at least one of the broadcasted usage transactions and temporary usage transactions, and generates and stores blocks corresponding to at least one of the verified usage transactions and temporary usage transactions.

According to one embodiment, the usage transaction generator may generate the usage transaction when use of the content is normally terminated, and may generate the temporary usage transaction before the usage transaction is generated.

According to one embodiment, the usage transaction generator may generate the temporary usage transactions at regular intervals, or may generate the temporary usage transactions in response to an externally received request signal.

According to one embodiment, when the next temporary usage transaction or the usage transaction is not received during a critical time after the broadcasted temporary usage transaction is received, the service system may analyze the current status of usage of content using the last received temporary usage transaction.

According to one embodiment, when the usage transaction is received, the service system may analyze the current status of usage of content using the usage transaction.

According to one embodiment, the service system may calculate micro-billing information based on the analyzed current status of usage.

According to one embodiment, the service system may calculate recommended content information corresponding to a user based on the analyzed current status of usage.

In accordance with yet another aspect of the present disclosure, there is provided a content distribution management method using blockchain technology, including a step of generating a purchase transaction in response to a content purchase request signal from a user terminal; a step of broadcasting the generated purchase transaction; a step of collecting usage transactions generated in response to the current status of usage of the content when content corresponding to the verified purchase transaction is used in the user terminal after the broadcasted purchase transaction is verified; a step of verifying the collected usage transactions; and a step of generating blocks corresponding to the verified usage transactions, wherein the step of collecting includes a step of collecting temporary usage transactions generated in the user terminal during use of the content; and a step of analyzing the current status of usage of the content in consideration of the collected temporary usage transactions.

According to one embodiment, the step of analyzing the current status of usage of the content may include a step of determining whether the next temporary usage transaction or the usage transaction is received during a critical time after the temporary usage transaction is received; and a step of analyzing the current status of usage using the last received temporary usage transaction when the usage transaction is not received as a result of the determination.

According to one embodiment, the step of analyzing the current status of usage of the content may include a step of analyzing the current status of usage using the usage transaction when the usage transaction is received as a result of the determination.

According to one embodiment, the content distribution management method using blockchain technology may further include a step of calculating micro-billing information based on the analyzed current status of usage.

According to one embodiment, the content distribution management method using blockchain technology may further include a step of calculating recommended content information corresponding to a user based on the analyzed current status of usage.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a drawing for explaining a content distribution management system based on blockchain technology according to one embodiment;

FIG. 2 is a drawing for explaining a service system according to one embodiment;

FIG. 3 is a drawing for explaining a user terminal according to one embodiment; and

FIG. 4 is a drawing for explaining a content distribution management method based on blockchain technology according to one embodiment.

### DETAILED DESCRIPTION OF THE DISCLOSURE

Specific structural and functional descriptions of embodiments according to the concept of the present disclosure disclosed herein are merely illustrative for the purpose of explaining the embodiments according to the concept of the present disclosure. Furthermore, the embodiments according to the concept of the present disclosure can be implemented in various forms and the present disclosure is not limited to the embodiments described herein.

The embodiments according to the concept of the present disclosure may be implemented in various forms as various modifications may be made. The embodiments will be described in detail herein with reference to the drawings. However, it should be understood that the present disclosure is not limited to the embodiments according to the concept of the present disclosure, but includes changes, equivalents, or alternatives falling within the spirit and scope of the present disclosure.

The terms such as “first” and “second” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the teachings of the present disclosure.

It should be understood that when an element is referred to as being “connected to” or “coupled to” another element, the element may be directly connected or coupled to the other element or intervening elements may be present. In contrast, when an element is referred to as being “directly connected to” or “directly coupled to” another element, there are no intervening elements present. Other words used to describe the relationship between elements or layers should be interpreted in a like fashion (e.g., “between,” versus “directly between,” “adjacent,” versus “directly adjacent,” etc.).

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present disclosure will be described in detail with reference to the accompanying drawings. However, the scope of the present disclosure is not limited by these embodiments. Like reference numerals in the drawings denote like elements.

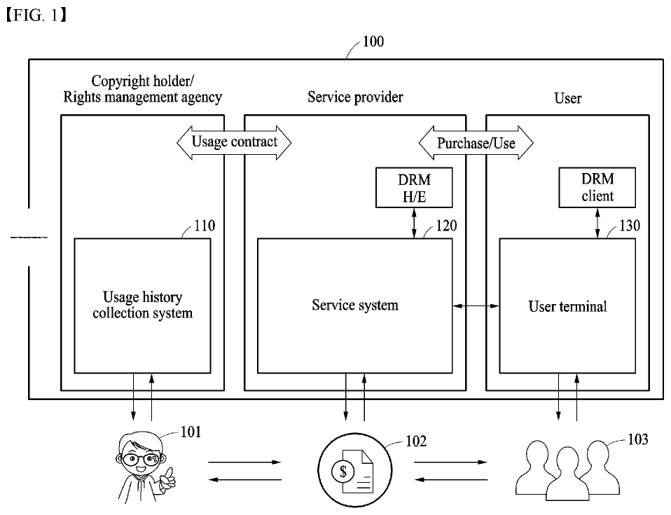

FIG. 1 is a drawing for explaining a content distribution management system 100 based on blockchain technology according to one embodiment.

A service system 120 according to one embodiment may provide content purchased by a user to a user terminal 130. In addition, the service system 120 according to one embodiment may generate a purchase transaction based on purchase of content, and the user terminal 130 may generate usage transactions for the content in response to the generated purchase transaction.

The purchase transaction used in the present specification may include information such as transaction IDs, purchasers, purchase time, content identifiers, and service provider identifiers so that a history of purchase of content may be grasped.

In addition, the usage transaction may include information such as transaction IDs, users, usage time, content identifiers, and service provider identifiers so that a history of usage of content may be grasped.

After a certain period of time has elapsed, the service system 120 may analyze the current status of usage of all content used by a user 103 through the content usage transaction, and may use the analysis results in billing processing 102.

The purchase transaction and usage transaction generated in this manner may be generated as a block for blockchain technology and then stored and shared for verification. In this case, the generated blocks may be stored and maintained in the form of a distributed ledger.

For example, the generated block may be stored as a distributed ledger in the form of a blockchain through a hash corresponding to a current block and a hash corresponding to a previous block. Based on blockchain technology, the generated blocks or distributed ledgers may be shared by all entities involved in content distribution. Therefore, it is fundamentally impossible to modify only a part of the transaction included in one block or blocks.

Specifically, content such as pictures, music, movies, and broadcasts generated by a content creator 101 may be pre-registered for copyright thereof for use in a usage history collection system 110.

The copyright may be transmitted to the user terminal for granting a usage right to the content after being encrypted by a digital rights management (DRM) server. For example, the user 103 may be a purchaser who purchased the content.

The digital rights management (DRM) server may encrypt the copyright of the content purchased by the user 103 and provide the encrypted copyright to the user terminal.

The user terminal 130 may decode the copyright of the content and use the content through the decoded copyright. The content may be transmitted to the user terminal 130 by the service system 120, and then may be displayed on the user terminal 130.

According to one embodiment, the user terminal 130 may include a mobile phone, a computer, a notebook, a display device, a speaker, a tablet PC, and the like owned by the user 103.

When the user terminal 130 outputs the content, it may be considered that the content is used.

A usage transaction may be generated when use of the content ends.

That is, when use of the content is normally terminated, the user terminal 130 may generate a usage transaction corresponding to the content and transmit the usage transaction to the service system 120. For example, the user terminal 130 may broadcast the generated usage transaction to a network, and the service system 120 connected to the network and the usage history collection system 110 may collect the broadcasted usage transaction. In addition, the service system 120 and the usage history collection system 110 may verify the collected usage transaction based on blockchain technology to determine whether the collected usage transaction is valid.

Once the usage transaction is verified, the service system 120 may generate a block by reflecting to the usage transaction, and may store the block in the form of a distributed ledger.

That is, the present disclosure provides blockchain technology for distributing a ledger in which transaction information is recorded to a P2P network rather than a central server so that participants may jointly manage the records. Therefore, the present disclosure may ensure integrity compared to conventional distribution-related or encryption-related technology. That is, the present disclosure may provide improved security, transparency, safety, and efficiency using blockchain technology.

In addition, the generated block may be transmitted to another entity for verification. Specifically, the service system 120 may broadcast the block generated by reflecting the usage transaction in the usage history collection system 110 and the user terminal 130. The usage history collection system 110 for collecting the block and the user terminal 130 may verify the block based on blockchain technology.

In this case, at least one of the usage history collection system 110 and the user terminal 130 may store the verified block. For example, in the case of the usage history collection system 110, the block may be cumulatively recorded in a database in the form of a distributed ledger, and may be held for a period time for verification.

In addition, in the case of the user terminal 130, only block verification may be performed in consideration of the storage space, and the verified block may be discarded. However, after block verification, the block may be recorded in a relatively small capacity storage medium such as a memory, a hard disk, and a cloud server only for a short period of time.

The service system 120 according to one embodiment may analyze the current status of usage of the content through the usage transaction received from the user terminal 130.

The current status of usage may include the total usage time, the usage time zone, the usage amount, the number of usage times, and the terminal used for use of the content.

For example, when content is a two-hour movie and a usage transaction is received, the service system 120 may analyze total usage time and determine that the user of the user terminal 130 has used the content for two hours based on the analysis result.

In addition, the usage time zone may be interpreted as a specific time zone during the 24-hours. For example, the service system 120 may discount a billing amount by assigning a negative weight to the billing amount given according to the current status of usage, except for the prime time period in which content is frequently viewed. On the other hand, the service system 120 may add an extra amount to a billing amount by assigning a positive weight to the billing amount given according to the current status of usage during a prime time period in which content is frequently viewed.

The usage amount may be differently analyzed depending on the quality of content. For example, when a means for outputting content is a portable terminal, problems do not arise even when the quality of the content is low. In addition, when a means for outputting content is a 60-inch Ultra-HD (UHD) TV, content having a higher quality than that of the portable terminal should be used.

Therefore, the service system 120 according to one embodiment may differently analyze the usage amount considering the quality of the content even when the content is of the same type.

The number of usage times may be analyzed using the number of times content has been played back. The service system 120 according to one embodiment may count the number of usage times in consideration of the frequency with which content is provided to a user terminal.

In addition, the analysis of the terminal used may depend on the type of the terminal that displays content.

The service system 120 according to one embodiment may use the cumulative usage status of content used by a user for billing.

A user terminal 130 according to one embodiment may generate temporary usage transactions until use of content is normally terminated after use of content is started. In addition, the terminal 130 may transmit the generated temporary usage transactions to the service system 120.

Therefore, according to the present disclosure, the current status of usage related to content distribution may be checked in detail by applying blockchain technology to content distribution management. In addition, micro-billing for content distribution may be implemented by applying blockchain technology to content distribution management.

For example, the user terminal 130 may generate and broadcast temporary usage transactions, and the service system 120 may collect and verify the broadcasted temporary usage transactions.

The current status of usage of content may be analyzed using the temporary usage transactions even when the viewing of the content is not normally terminated.

For example, the user terminal 130 may generate temporary usage transactions at intervals of 10 seconds and provide the temporary usage transactions to the service system 120.

In addition, it may be considered that the content is not normally terminated but half of the content is used due to the circumstances of the user terminal.

In this case, the user terminal 130 may not generate a usage transaction that is generated at the time of normal termination of content, and consequently, the service system 120 may not collect the usage transaction. As a result, the service system 120 may not analyze the current status of usage of the content through the usage transaction. In this case, the criterion of billing may not be established, so that both user and service provider may suffer a great loss.

The service system 120 according to one embodiment may collect temporary usage transactions when content is started. In addition, when a usage transaction generated when content is normally terminated is not collected, the service system 120 may use the last collected temporary usage transaction as the usage transaction.

For example, when content is a two-hour move, the service system 120 may consider the case wherein temporary usage transactions are collected only up to one hour after use of the content. In this case, the service system 120 may determine through analysis using the last collected temporary usage transaction that the two-hour movie has been half used.

That is, the service system 120 may analyze the current status of usage of content more finely and use the analyzed result for billing. In this case, the service system 120 may charge only the amount corresponding to ½ of the purchase price of the content.

In the case of the temporary usage transaction, when the (n+1)th temporary usage transaction is collected in the service system 120, the n-th temporary usage transaction may be deleted from a buffer.

In addition, when the generation period of temporary usage transactions is shortened in the user terminal 130, billing for content may be made more finely. For example, the service system 120 may use temporary usage transactions to charge differently calculated amounts to a user who used for 10 minutes and a user who used for 11 minutes for the same content.

According to the present disclosure, a model for a novel content distribution management platform to which blockchain technology is applied may be designed, thereby securing technical competitiveness. In addition, the reliability of billing may be improved using blockchain technology capable of implementing the integrity of content distribution management.

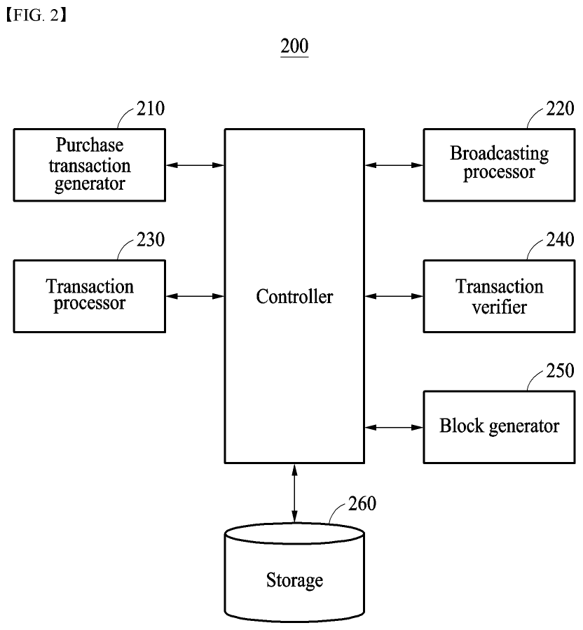

FIG. 2 is a drawing for explaining a service system 200 according to one embodiment.

The service system 200 according to one embodiment may generate transactions according to purchase and use of content, generate blocks based on the generated transactions, and store the blocks in the form of a distributed ledger, thereby ensuring the integrity of content distribution and flows related thereto.

The service system 200 may include a purchase transaction generator 210, a broadcasting processor 220, a transaction processor 230, a transaction verifier 240, and a block generator 250.

The purchase transaction generator 210 according to one embodiment may generate a purchase transaction in response to a content purchase request signal from a user terminal.

The user may generate an intention to purchase content. For example, the user may request purchase of specific content through the portable terminal of the user. In addition, the user may request purchase of content for controlling the user terminal.

When the purchase request is generated by the user, the purchase transaction generator 210 may check the content purchase request signal transmitted from the user terminal and generate a purchase transaction for the content in response to the request.

The purchase transaction may include identification information on the content, identification information on the user, purchase time, content information, usage rights, and the like.

The broadcasting processor 220 according to one embodiment may broadcast the generated purchase transaction.

The user terminal may collect and verify the broadcasted purchase transaction. In addition, a usage history collection system may collect and verify the broadcasted purchase transaction.

After verification of the broadcasted purchase transaction, when content corresponding to the verified purchase transaction is used in the user terminal, the transaction processor 230 according to one embodiment may collect a usage transaction generated in response to the current status of usage of the content.

For example, when use of the content is normally terminated, the user terminal may generate a usage transaction and broadcast the same. In this case, the transaction processor 230 according to one embodiment may collect the broadcasted usage transaction.

The transaction verifier 240 according to one embodiment may verify the collected usage transaction. Verification of the usage transaction may be performed based on blockchain technology. For example, the transaction verifier 240 may perform verification by comparing a usage transaction collected by the usage history collection system and a usage transaction collected by the transaction processor 230.

The block generator 250 according to one embodiment may generate a block corresponding to the verified usage transaction.

In addition, the transaction processor 230 according to one embodiment may collect temporary usage transactions generated in the user terminal during use of content, and may analyze the current status of usage of the content in consideration of the collected temporary usage transactions.

For this purpose, when use of the content is normally terminated, the user terminal according to one embodiment may generate and broadcast a usage transaction. Before a usage transaction is generated, the user terminal may generate and broadcast temporary usage transactions.

In addition, the user terminal according to one embodiment may generate temporary usage transactions at regular intervals, or may generate temporary usage transactions in response to an externally received request signal.

The transaction processor 230 according to one embodiment may determine whether the next temporary usage transaction or usage transaction is received during a critical time after a temporary usage transaction is received.

When no transaction is received, the transaction processor 230 may analyze the current status of usage using the last received temporary usage transaction.

The transaction processor 230 may determine that the content is normally terminated when the usage transaction is received, and may analyze the current status of usage using the usage transaction.

Accordingly, the transaction processor 230 may calculate micro-billing information based on the analyzed current status of usage.

In addition, the transaction processor 230 may calculate recommended content information corresponding to a user based on the analyzed current status of usage.

For example, as a result of analyzing the current status of usage of content, when content of the thriller genre is watched from beginning to end, and content of the drama genre is watched by one third, a weight may be applied to the content of the thriller genre, and content of the thriller genre may be recommended to the user.

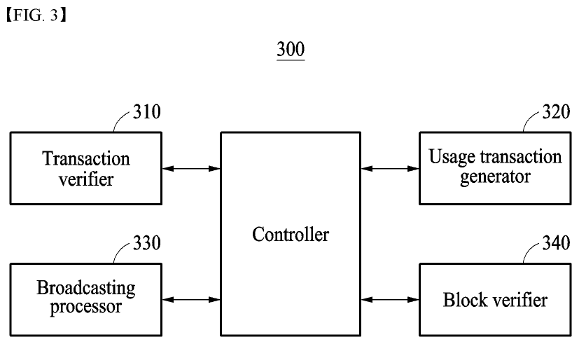

FIG. 3 is a drawing for explaining a user terminal 300 according to one embodiment.

The user terminal 300 according to one embodiment may generate a usage transaction according to content usage, or may verify a purchase transaction and a usage transaction.

In addition, when necessary, the user terminal 300 may store a block generated according to the transaction, and may compare the block with a block holding another entity, thereby verifying the integrity of the transaction.

For this purpose, the user terminal 300 according to one embodiment may include a transaction verifier 310, a usage transaction generator 320, and a broadcasting processor 330. In addition, the user terminal 300 may further include a block verifier 340 for verifying blocks supplied from the service system.

In addition, the service system according to one embodiment may broadcast the generated blocks. In this case, the service system may collect and verify the blocks broadcasted through the block verifier 340 of the user terminal 300.

The block verifier 340 according to one embodiment may be included as a component of the user terminal 300, and may be implemented as a part of the transaction verifier 310.

First, the transaction verifier 310 according to one embodiment may receive purchase transactions generated in the service system, and may verify the received purchase transactions.

A user may generate an intention to purchase content. For example, the user may request purchase of specific content through the portable terminal of the user. In addition, the user may request purchase of content for controlling the user terminal.

When the purchase request is generated by the user, the service system may check the content purchase request signal and generate a purchase transaction for the content in response to the request.

The purchase transaction may include identification information on the content, identification information on the user, purchase time, content information, usage rights, and the like.

In addition, the service system may broadcast the generated purchase transaction, and the transaction verifier 310 may collect and verify the broadcasted purchase transaction.

Next, the usage transaction generator 320 according to one embodiment may generate a usage transaction by reflecting the current status of usage of the content corresponding to the verified purchase transaction, and may generate temporary usage transactions during use of the content.

For example, the usage transaction generator 320 may generate the usage transaction when use of the content is normally terminated. In addition, the usage transaction generator 320 may generate temporary usage transactions before the usage transaction is generated.

In particular, the usage transaction generator 320 may generate the temporary usage transactions at regular intervals, or may generate the temporary usage transactions in response to an externally received request signal.

The service system may collect and verify at least one of the broadcasted usage transaction and the broadcasted temporary usage transaction. In addition, the service system may generate and store a block corresponding to at least one of the verified usage transaction and temporary usage transaction.

For example, when the broadcasted temporary usage transaction is received, and then the next temporary usage transaction is not received during a critical time, the service system may analyze the current status of usage of the content using the last received temporary usage transaction. That is, the service system may analyze the current status of usage by setting the last received temporary usage transaction as a usage transaction.

In addition, when a usage transaction generated when use of the content is normally terminated is received, the service system may analyze the current status of usage of the content using the usage transaction.

The service system according to one embodiment may calculate micro-billing information based on the analyzed current status of usage. In addition, the service system may calculate recommended content information corresponding to a user based on the analyzed current status of usage.

The broadcasting processor 330 according to one embodiment may broadcast at least one of the generated usage transaction and temporary usage transaction.

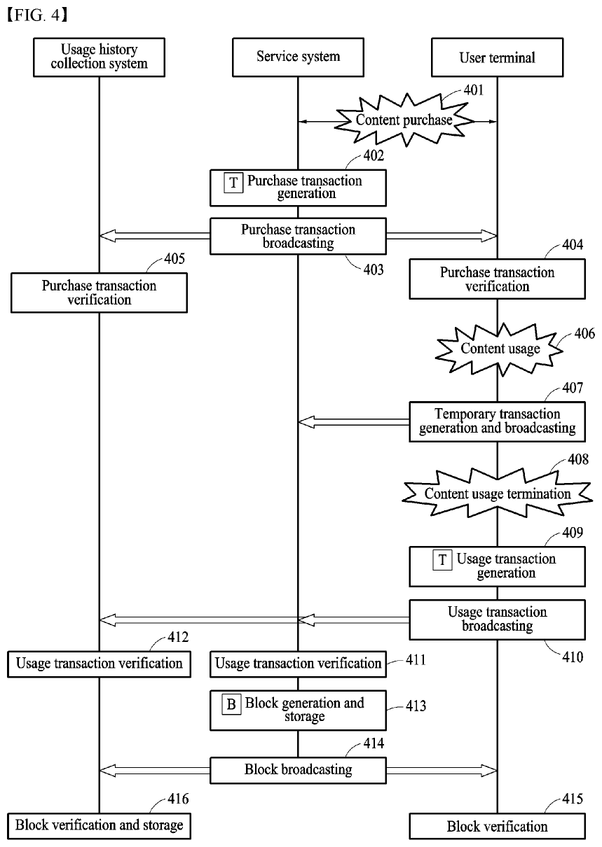

FIG. 4 is a drawing for explaining a content distribution management method based on blockchain technology according to one embodiment.

According to the content distribution management method based on blockchain technology according to one embodiment, a user terminal may transmit a content purchase request signal to a service system according to the content purchase request of the user (401).

In this embodiment, a content purchase request signal is transmitted from the user terminal to the service system. However, a content purchase request signal may be transmitted from various devices to the service system. In addition, content corresponding to a purchase request signal may be provided from the service system to the user terminal.

According to the content distribution management method based on blockchain technology according to one embodiment, the service system may generate a purchase transaction according to a content purchase request (402), and may broadcast the generated purchase transaction (403).

The broadcasted purchase transaction may be collected in a usage history collection system and a user terminal. Each of the usage history collection system and the user terminal may verify the collected purchase transaction (404, 405).

In addition, content may be used through the user terminal in response to the generated purchase transaction (406). For example, content provided by the service system may be received through the user terminal in a downloading or streaming manner, and may be controlled to be displayed on the display of the user terminal.

According to the content distribution management method based on blockchain technology according to one embodiment, the user terminal may generate temporary usage transactions until use of content is normally terminated after use of content is started (407). In addition, the user terminal may broadcast the generated temporary usage transactions to the service system (407).

According to the present disclosure, the current status of usage related to content distribution may be checked in detail using blockchain technology. In addition, micro-billing for content distribution may be implemented by applying blockchain technology to content distribution management.

According to the content distribution management method based on blockchain technology according to one embodiment, the service system may collect temporary usage transactions when content is started. In addition, when a usage transaction generated when content is normally terminated is not collected, the service system may use the last collected temporary usage transaction as the usage transaction.

For example, when the (n+1)th temporary usage transaction is collected in the service system, the n-th temporary usage transaction may be deleted from a buffer.

According to the content distribution management method based on blockchain technology according to one embodiment, when use of the content is normally terminated (408), the user terminal may generate a usage transaction corresponding to the content (409) and broadcast the usage transaction (410).

The broadcasted usage transaction may be collected in the usage history collection system and the service system, and each of the usage history collection system and the service system may verify the collected usage transaction (411 and 412).

For example, the user terminal may broadcast the generated usage transaction to a network, and the service system connected to the network and the usage history collection system may collect the broadcasted usage transaction. In addition, the service system and the usage history collection system may verify the collected usage transaction based on blockchain technology to determine whether the collected usage transaction is valid.

Once the usage transaction is verified, the service system may generate a block by reflecting to the usage transaction, and may store the block in the form of a distributed ledger (413).

That is, the present disclosure provides blockchain technology for distributing a ledger in which transaction information is recorded to a P2P network rather than a central server so that participants may jointly manage the records. Therefore, the present disclosure may ensure integrity compared to conventional distribution-related or encryption-related technology. That is, the present disclosure may provide improved security, transparency, safety, and efficiency using blockchain technology.

According to the content distribution management method based on blockchain technology according to one embodiment, the service system may broadcast the generated block to another entity for verification (414).

Specifically, the service system may broadcast the block generated by reflecting the usage transaction in the usage history collection system and the user terminal. The usage history collection system for collecting the block and the user terminal may verify the block based on blockchain technology (415 and 416).

In this case, at least one of the usage history collection system and the user terminal may store the verified block.

According to the content distribution management method based on blockchain technology according to one embodiment, in the case of the usage history collection system, the block may be cumulatively recorded in a database in the form of a distributed ledger, and may be held for a period time for verification.

According to the content distribution management method based on blockchain technology according to one embodiment, in the service system, the current status of usage of the content may be analyzed using the usage transaction transmitted from the user terminal.

According to the content distribution management method based on blockchain technology according to one embodiment, in the service system, the current status of usage of the content used by a user may be accumulated, and the accumulated current status of usage may be used for billing.

Therefore, the present disclosure may provide a model for novel content distribution management. In addition, the integrity of content distribution management may be secured by applying blockchain technology to content distribution management, thereby blocking and preventing illegal distribution of content.

In addition, the present disclosure may provide blockchain technology for distributing a ledger in which transaction information is recorded to a P2P network rather than a central server so that participants may jointly manage the records. Therefore, in the conventional method, a trusted third party (TTP) for trusting the database of a central server is required, but the present disclosure may omit such a requirement. In addition, compared to conventional centralized systems, the present disclosure may improve security, transparency, safety, and efficiency using blockchain technology.

According to one embodiment, the present disclosure can provide a model for novel content distribution management.

According to one embodiment, the present disclosure can ensure the integrity of content distribution management by applying blockchain technology to content distribution management.

According to one embodiment, the present disclosure can block and prevent illegal distribution of content by applying blockchain technology to content distribution management.

According to one embodiment, a model for a novel content distribution management platform to which blockchain technology is applied can be designed.

According to one embodiment, technical competitiveness for a novel content distribution management platform can be secured.

According to one embodiment, the reliability of billing can be improved using blockchain technology capable of implementing the integrity of content distribution management.

According to one embodiment, the current status of usage related to content distribution can be checked in detail by applying blockchain technology to content distribution management.

According to one embodiment, micro-billing for content distribution can be implemented by applying blockchain technology to content distribution management.

According to one embodiment, the present disclosure can provide blockchain technology for distributing a ledger in which transaction information is recorded to a P2P network rather than a central server so that participants may jointly manage the records. Therefore, in the conventional method, a trusted third party (TTP) for trusting the database of a central server is required, but the present disclosure can omit such a requirement.

According to one embodiment, compared to conventional centralized systems, the present disclosure can improve security, transparency, safety, and efficiency using blockchain technology.

The apparatus described above may be implemented as a hardware component, a software component, and/or a combination of hardware components and software components. For example, the apparatus and components described in the embodiments may be achieved using one or more general purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications executing on the operating system. In addition, the processing device may access, store, manipulate, process, and generate data in response to execution of the software. For ease of understanding, the processing apparatus may be described as being used singly, but those skilled in the art will recognize that the processing apparatus may include a plurality of processing elements and/or a plurality of types of processing elements. For example, the processing apparatus may include a plurality of processors or one processor and one controller. Other processing configurations, such as a parallel processor, are also possible.

The software may include computer programs, code, instructions, or a combination of one or more of the foregoing, configure the processing apparatus to operate as desired, or command the processing apparatus, either independently or collectively. In order to be interpreted by a processing device or to provide instructions or data to a processing device, the software and/or data may be embodied permanently or temporarily in any type of a machine, a component, a physical device, a virtual device, a computer storage medium or device, or a transmission signal wave. The software may be distributed over a networked computer system and stored or executed in a distributed manner. The software and data may be stored in one or more computer-readable recording media.

The methods according to the embodiments of the present disclosure may be implemented in the form of a program command that can be executed through various computer means and recorded in a computer-readable medium. The computer-readable medium can store program commands, data files, data structures or combinations thereof. The program commands recorded in the medium may be specially designed and configured for the present disclosure or be known to those skilled in the field of computer software. Examples of a computer-readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include machine language code generated by a compiler and high-level language code executable by a computer using an interpreter and the like. The hardware devices described above may be configured to operate as one or more software modules to perform the operations of the embodiments, and vice versa.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

1. A content distribution management system using blockchain technology, comprising:
a purchase transaction generator for generating a purchase transaction in response to a content purchase request signal from a user terminal;
a broadcasting processor for broadcasting the generated purchase transaction;
a transaction processor, in which, when content corresponding to the verified purchase transaction is used in the user terminal after the broadcasted purchase transaction is verified, usage transactions generated in response to a current status of usage of the content are collected;
a transaction verifier for verifying the collected usage transactions; and
a block generator for generating blocks corresponding to the verified usage transactions,
wherein the transaction processor collects temporary usage transactions generated in the user terminal during use of the content, and analyzes current status of usage of the content in consideration of the collected temporary usage transactions.

2. The content distribution management system according to claim 1, wherein the user terminal generates and broadcasts the usage transaction when use of the content is normally terminated, and generates and broadcasts the temporary usage transaction before the usage transaction is generated.

3. The content distribution management system according to claim 1, wherein the user terminal generates the temporary usage transactions at regular intervals, or generates the temporary usage transactions in response to an externally received request signal.

4. The content distribution management system according to claim 1, wherein, when a next temporary usage transaction or the usage transaction is not received during a critical time after the temporary usage transaction is received, the transaction processor analyzes the current status of usage using the last received temporary usage transaction.

5. The content distribution management system according to claim 1, wherein, when the usage transactions are received, the transaction processor analyzes the current status of usage using the usage transactions.

6. The content distribution management system according to claim 1, wherein the transaction processor calculates micro-billing information based on the analyzed current status of usage.

7. The content distribution management system according to claim 1, wherein the transaction processor calculates recommended content information corresponding to a user based on the analyzed current status of usage.

8. The content distribution management system according to claim 1, wherein the current status of usage comprises at least one of a total usage time, a usage time zone, a usage amount, the number of usage times, and a terminal used for the content.

9. The content distribution management system according to claim 1, wherein the broadcasting processor broadcasts the generated blocks to the user terminal and a usage history collection system, and
the user terminal and the usage history collection system collect and verify the broadcasted blocks.

10. A content distribution management system using blockchain technology, comprising:
a transaction verifier for receiving a purchase transaction generated in a service system when content is purchased and for verifying the received purchase transaction;
a usage transaction generator for generating usage transactions by reflecting a current status of usage of the content corresponding to the verified purchase transaction and generating temporary usage transactions during use of the content; and
a broadcasting processor for broadcasting at least one of the generated usage transactions and temporary usage transactions,
wherein the service system collects and verifies at least one of the broadcasted usage transactions and temporary usage transactions, and generates and stores blocks corresponding to at least one of the verified usage transactions and temporary usage transactions.

11. The content distribution management system according to claim 10, wherein the usage transaction generator generates the usage transactions when use of the content is normally terminated, and generates the temporary usage transactions before the usage transactions are generated.

12. The content distribution management system according to claim 11, wherein the usage transaction generator generates the temporary usage transactions at regular intervals, or generates the temporary usage transactions in response to an externally received request signal.

13. The content distribution management system according to claim 10, wherein, when a next temporary usage transaction or the usage transaction is not received during a critical time after the broadcasted temporary usage transaction is received, the service system analyzes a current status of usage of content using the last received temporary usage transaction when the usage transaction is received, the service system analyzes a current status of usage of content using the usage transaction.

14. (canceled)

15. The content distribution management system according to claim 13, wherein the service system calculates micro-billing information based on the analyzed current status of usage.

16. The content distribution management system according to claim 13, wherein the service system calculates recommended content information corresponding to a user based on the analyzed current status of usage.

17. A content distribution management method using blockchain technology, comprising:
generating a purchase transaction in response to a content purchase request signal from a user terminal;
broadcasting the generated purchase transaction;
collecting usage transactions generated in response to a current status of usage of the content when content corresponding to the verified purchase transaction is used in the user terminal after the broadcasted purchase transaction is verified;
verifying the collected usage transactions; and
generating blocks corresponding to the verified usage transactions,
wherein the collecting comprises collecting temporary usage transactions generated in the user terminal during use of the content; and
analyzing a current status of usage of the content in consideration of the collected temporary usage transactions.

18. The content distribution management method according to claim 17, wherein the analyzing of a current status of usage of the content comprises determining whether a next temporary usage transaction or the usage transaction is received during a critical time after the temporary usage transaction is received; and
analyzing the current status of usage using a last received temporary usage transaction when the usage transaction is not received as a result of the determination.

19. The content distribution management method according to claim 18, wherein the analyzing of a current status of usage of the content comprises analyzing the current status of usage using the usage transaction when the usage transaction is received as a result of the determination.

20. The content distribution management method according to claim 17, further comprising calculating micro-billing information based on the analyzed current status of usage.

21. The content distribution management method according to claim 17, further comprising calculating recommended content information corresponding to a user based on the analyzed current status of usage.
